(19) United States
(12) Patent Application Publication
(10) Pub. No.: US 2026/0067904 A1
(43) Pub. Date: Mar. 5, 2026

(54) METHOD AND APPARATUS FOR PROCESSING SIDELINK CONSISTENT LISTEN-BEFORE-TALK FAILURE, AND TERMINAL

(71) Applicant: VIVO MOBILE COMMUNICATION CO., LTD., Guangdong (CN)

(72) Inventors: Jianhui LI, Dongguan (CN); Zichao JI, Dongguan (CN)

(73) Assignee: VIVO MOBILE COMMUNICATION CO., LTD., Guangdong (CN)

(21) Appl. No.: 19/383,519

(22) Filed: Nov. 7, 2025

Related U.S. Application Data
(63) Continuation of application No. PCT/CN2024/091334, filed on May 7, 2024.

(30) Foreign Application Priority Data
May 11, 2023 (CN) 202310534226.9

(51) Int. Cl. H04W 72/25; H04W 74/0808

(52) U.S. Cl. CPC H04W 72/25; H04W 74/0808

(57) ABSTRACT

Disclosed in the present application are a method and apparatus for processing a sidelink consistent listen-before-talk failure, and a terminal. The method includes: a terminal determining that a sidelink consistent listen-before-talk failure is triggered on a target resource; and the terminal executing a first operation, wherein the first operation includes at least one of the following: clearing a first sidelink licensed resource, which includes the target resource on which the sidelink consistent listen-before-talk failure is triggered; executing resource selection or re-selection for the first sidelink licensed resource; performing resource pool re-selection; and canceling a sidelink consistent listen-before-talk failure which has been triggered, but has not been canceled on the target resource.

### CROSS-REFERENCE TO RELATED APPLICATIONS

This application is a U.S. Continuation application of International Application No. PCT/CN2024/091334, filed on May 7, 2024, which claims the benefit of priority to Chinese Patent Application No. 202310534226.9, filed with the China National Intellectual Property Administration on May 11, 2023, and entitled “METHOD AND APPARATUS FOR PROCESSING SIDELINK CONSISTENT LISTEN-BEFORE-TALK FAILURE, AND TERMINAL”, both of which are incorporated herein by reference in their entireties for all purposes.

### TECHNICAL FIELD

This application pertains to the field of wireless communication technologies, and specifically relates to a method and an apparatus for processing a sidelink consistent listen-before-talk failure, and a terminal.

### BACKGROUND

Sidelink (sidelink, SL) transmission refers to data transmission directly performed at a physical layer between terminals (which may also be referred to as user equipment (User Equipment, UE)). In a long term evolution (Long Term Evolution, LTE) sidelink, communication is performed based on broadcast. Although the LTE sidelink can be used to support basic safety communication in vehicle to everything (vehicle to everything, V2X), the LTE sidelink is not applicable to other more advanced V2X services. A 5G new radio (New Radio) system supports a more advanced sidelink transmission design, such as unicast, multicast, or groupcast, so that more comprehensive services can be supported.

In a future communication system, an unlicensed band (Unlicensed band) may be used to supplement a licensed band (Licensed band), to help an operator expand services. Because the unlicensed band is shared by a plurality of radio access technologies (Radio Access Technology, RAT), such as Wireless Fidelity (Wireless Fidelity, Wi-Fi), radar, and LTE license assisted access (License Assisted Access, LAA), in some countries or regions, use of the unlicensed band needs to comply with regulations such as listen before talk (Listen before talk, LBT), to ensure that all devices can use resources fairly.

Because there is resource contention with other RAT terminals such as Wi-Fi terminals in the unlicensed band, UE may consistently detect an LBT failure. This means that a channel is busy for a period of time currently, and that normal communication may not be possible. Therefore, UE communicating with a network-side device through a Uu interface in new radio (New Radio, NR) supports “consistent LBT failure” (Consistent LBT failure) detection and a related processing mechanism. A cumulative count of LBT failures that occur on a currently active bandwidth part (Bandwidth Part, BWP) of each cell is recorded, and when the cumulative count reaches a threshold configured by a network, a consistent LBT failure is triggered. Then a consistent LBT failure processing procedure is performed.

However, the related art provides only a procedure for processing a consistent LBT failure on a Uu interface for a terminal, and sidelink transmission is not exactly the same as transmission on the Uu interface. Therefore, after a sidelink consistent listen-before-talk failure is triggered, how the terminal performs corresponding processing is a technical problem to be resolved in the related art.

### SUMMARY

According to a first aspect, a method for processing a sidelink consistent listen-before-talk failure is provided. The method includes: determining, by a terminal, that a sidelink consistent listen-before-talk failure is triggered on a target resource; and performing, by the terminal, a first operation, where the first operation includes at least one of the following: clearing a first sidelink grant resource, where the first sidelink grant resource includes the target resource on which the sidelink consistent listen-before-talk failure has been triggered; performing resource selection or reselection for the first sidelink grant resource; performing resource pool reselection; and canceling the sidelink consistent listen-before-talk failure that has been triggered but has not been canceled on the target resource.

According to a second aspect, an apparatus for processing a sidelink consistent listen-before-talk failure is provided. The apparatus includes: a determining module, configured to determine that a sidelink consistent listen-before-talk failure is triggered on a target resource; and an execution module, configured to perform a first operation, where:
the first operation includes at least one of the following:
clearing a first sidelink grant resource, where the first sidelink grant resource includes the target resource on which the sidelink consistent listen-before-talk failure has been triggered;
performing resource selection or reselection for the first sidelink grant resource;
performing resource pool reselection; and
canceling the sidelink consistent listen-before-talk failure that has been triggered but has not been canceled on the target resource.

According to a third aspect, a method for configuring a sidelink consistent listen-before-talk failure is provided and includes: sending, by a network-side device, configuration information to a terminal, where the configuration information is used to indicate a target time period, and after a sidelink consistent listen-before-talk failure is triggered on a target resource, the target time period is used for the terminal to determine to clear a first sidelink grant resource including the target resource in the target time period, or determine to perform resource selection or reselection for a first sidelink grant resource including the target resource in the target time period.

According to a fourth aspect, an apparatus for configuring a sidelink consistent listen-before-talk failure is provided and includes: an obtaining module, configured to obtain configuration information of a terminal, where the configuration information is used to indicate a target time period, and after a sidelink consistent listen-before-talk failure is triggered on a target resource, the target time period is used for the terminal to determine to clear a first sidelink grant resource including the target resource in the target time period, or determine to perform resource selection or reselection for a first sidelink grant resource including the target resource in the target time period; and a sending module, configured to send the configuration information to the terminal.

According to a fifth aspect, a terminal is provided. The terminal includes a processor and a memory. The memory stores a program or instructions capable of running on the processor. When the program or instructions are executed by the processor, the steps of the method for processing a sidelink consistent listen-before-talk failure according to the first aspect are implemented.

According to a sixth aspect, a network-side device is provided. The network-side device includes a processor and a memory. The memory stores a program or instructions capable of running on the processor. When the program or instructions are executed by the processor, the steps of the method for configuring a sidelink consistent listen-before-talk failure according to the third aspect are implemented.

According to a seventh aspect, a readable storage medium is provided. The readable storage medium stores a program or instructions. When the program or instructions are executed by a processor, the steps of the method for processing a sidelink consistent listen-before-talk failure according to the first aspect are implemented, or the steps of the method for configuring a sidelink consistent listen-before-talk failure according to the third aspect are implemented.

According to an eighth aspect, a chip is provided. The chip includes a processor and a communication interface. The communication interface is coupled to the processor. The processor is configured to run a program or instructions to implement the steps of the method for processing a sidelink consistent listen-before-talk failure according to the first aspect or implement the steps of the method for configuring a sidelink consistent listen-before-talk failure according to the third aspect.

According to a ninth aspect, a computer program or program product is provided. The computer program or program product is stored in a storage medium. The computer program or program product is executed by at least one processor to implement the steps of the method for processing a sidelink consistent listen-before-talk failure according to the first aspect or implement the steps of the method for configuring a sidelink consistent listen-before-talk failure according to the third aspect.

According to a tenth aspect, a system for a sidelink consistent listen-before-talk failure is provided and includes a terminal and a network-side device. The terminal is configured to implement the steps of the method for processing a sidelink consistent listen-before-talk failure according to the first aspect. The network-side device is configured to implement the steps of the method for configuring a sidelink consistent listen-before-talk failure according to the third aspect.

### BRIEF DESCRIPTION OF DRAWINGS

FIG. 1 is a block diagram of a wireless communication system to which an embodiment of this application may be applied;

FIG. 2 is a block diagram of another wireless communication system to which an embodiment of this application may be applied;

FIG. 3 is a schematic diagram of a structure of an NR sidelink resource according to an embodiment of this application;

FIG. 4 is a schematic flowchart of a method for processing a sidelink consistent listen-before-talk failure according to an embodiment of this application;

FIG. 5 is a schematic diagram of a sidelink consistent listen-before-talk failure according to an embodiment of this application;

FIG. 6 is a schematic flowchart of another method for processing a sidelink consistent listen-before-talk failure according to an embodiment of this application;

FIG. 7 is a schematic flowchart of still another method for processing a sidelink consistent listen-before-talk failure according to an embodiment of this application;

FIG. 8 is a schematic flowchart of still another method for processing a sidelink consistent listen-before-talk failure according to an embodiment of this application;

FIG. 9 is a schematic flowchart of still another method for processing a sidelink consistent listen-before-talk failure according to an embodiment of this application;

FIG. 10 is a schematic flowchart of a method for configuring a sidelink consistent listen-before-talk failure according to an embodiment of this application;

FIG. 11 is a schematic diagram of an apparatus for processing a sidelink consistent listen-before-talk failure according to an embodiment of this application;

FIG. 12 is a schematic diagram of an apparatus for configuring a sidelink consistent listen-before-talk failure according to an embodiment of this application;

FIG. 13 is a schematic diagram of a structure of a communication device according to an embodiment of this application;

FIG. 14 is a schematic diagram of a hardware structure of a terminal according to an embodiment of this application; and

FIG. 15 is a schematic diagram of a hardware structure of a network-side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are only some rather than all of the embodiments of this application. All other embodiments obtained by a person of ordinary skill in the art based on the embodiments of this application shall fall within the protection scope of this application.

The terms “first”, “second”, and the like in this application are used to distinguish between similar objects instead of describing a specified order or sequence. It should be understood that the terms used in this way are interchangeable in appropriate circumstances, so that the embodiments of this application can be implemented in other orders than the order illustrated or described herein. In addition, objects distinguished by “first” and “second” usually fall within one class, and a quantity of objects is not limited. For example, there may be one or more first objects. In addition, the term “or” in this application indicates at least one of connected objects. For example, “A or B” covers three schemes, that is, scheme 1: including A and excluding B; scheme 2: including B and excluding A; and scheme 3: including both A and B. The character “/” generally indicates an “or” relationship between associated objects.

The term “indication” in this application may be either a direct indication (or an explicit indication) or an indirect indication (or an implicit indication). The direct indication may be understood as follows: A sender explicitly notifies a receiver, in a sent indication, of content such as specific information, an operation to be performed, or a result being requested. The indirect indication may be understood as follows: A receiver determines corresponding information based on an indication sent by a sender, or makes a decision and determines, based on a decision result, an operation to be performed or a result being requested, or the like.

It should be noted that technologies described in the embodiments of this application are not limited to a long term evolution (Long Term Evolution, LTE)/LTE-Advanced (LTE-Advanced, LTE-A) system, and can also be used in other wireless communication systems, such as code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), single-carrier frequency division multiple access (Single-carrier Frequency Division Multiple Access, SC-FDMA), or other systems. The terms “system” and “network” in the embodiments of this application are usually used interchangeably. The described technologies may be used for the foregoing systems and radio technologies, and may also be used for other systems and radio technologies. In the following descriptions, a new radio (New Radio, NR) system is described for an illustrative purpose, and NR terms are used in most of the following descriptions. These technologies may also be applied to other systems than the NR system, for example, a 6th Generation (6th Generation, 6G) communication system.

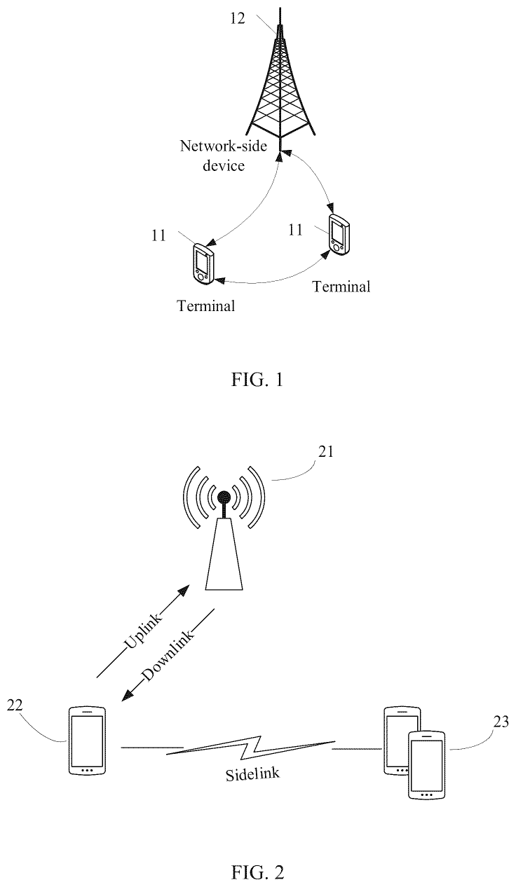

FIG. 1 is a block diagram of a wireless communication system to which an embodiment of this application may be applied. The wireless communication system includes a terminal 11 and a network-side device 12. The terminal 11 may be a terminal-side device such as a mobile phone, a tablet personal computer (Tablet Personal Computer), a laptop computer (Laptop Computer), a notebook computer, a personal digital assistant (Personal Digital Assistant, PDA), a palmtop computer, a netbook, an ultra-mobile personal computer (ultra-mobile personal computer, UMPC), a mobile Internet device (Mobile Internet Device, MID), an augmented reality (Augmented Reality, AR) or virtual reality (Virtual Reality, VR) device, a robot, a wearable device (Wearable Device), a flight vehicle (flight vehicle), vehicle user equipment (Vehicle User Equipment, VUE), shipborne equipment, pedestrian user equipment (Pedestrian User Equipment, PUE), a smart home (a home device having a wireless communication function, such as a refrigerator, a television, a washing machine, or furniture), a game console, a personal computer (Personal Computer, PC), a teller machine, or a self-service machine. The wearable device includes a smartwatch, a smart band, a smart headphone, smart glasses, smart jewelry (a smart bracelet, a smart wrist chain, a smart ring, a smart necklace, a smart anklet, a smart ankle chain, or the like), a smart wristband, smart clothing, or the like. The vehicle user equipment may also be referred to as a vehicle-mounted terminal, a vehicle-mounted controller, a vehicle-mounted module, a vehicle-mounted component, a vehicle-mounted chip, a vehicle-mounted unit, or the like. It should be noted that a specific type of the terminal 11 is not limited in the embodiments of this application. The network-side device 12 may include an access network device or a core network device. The access network device may also be referred to as a radio access network (Radio Access Network, RAN) device, a radio access network function, or a radio access network element. The access network device may include a base station, a wireless local area network (Wireless Local Area Network, WLAN) access point (Access Point, AP), a wireless fidelity (Wireless Fidelity, Wi-Fi) node, or the like. The base station may be referred to as a NodeB (NodeB, NB), an evolved NodeB (Evolved NodeB, eNB), a next generation NodeB (next generation NodeB, gNB), a new radio NodeB (New Radio NodeB, NR NodeB), an access point, a relay base station (Relay Base Station, RBS), a serving base station (Serving Base Station, SBS), a base transceiver station (Base Transceiver Station, BTS), a radio base station, a radio transceiver, a basic service set (Basic Service Set, BSS), an extended service set (Extended Service Set, ESS), a home NodeB (home NodeB, HNB), a home evolved NodeB (home evolved NodeB), a transmission reception point (Transmission Reception Point, TRP), or another appropriate term in the art. As long as the same technical effect is achieved, the base station is not limited to specific technical terms. It should be noted that in the embodiments of this application, only a base station in an NR system is used as an example, but a specific type of the base station is not limited.

FIG. 2 is a block diagram of another wireless communication system to which an embodiment of this application may be applied. Referring to FIG. 2, the wireless communication system includes a network-side device 21, a terminal 22, and a terminal 23. The network-side device 21 transmits downlink (Downlink, DL) data to the terminal 22, the terminal 22 transmits uplink (Uplink, UL) data to the network-side device 21, and sidelink (Sidelink, SL) data transmission is performed between the terminal 22 and the terminal 23.

In addition, an R16 NR sidelink includes the following channels: a physical sidelink control channel (physical sidelink control channel, PSCCH), a physical sidelink shared channel (physical sidelink shared channel, PSSCH), a physical sidelink broadcast channel (physical sidelink broadcast channel, PSBCH), and a physical sidelink feedback channel (physical sidelink feedback channel, PSFCH).

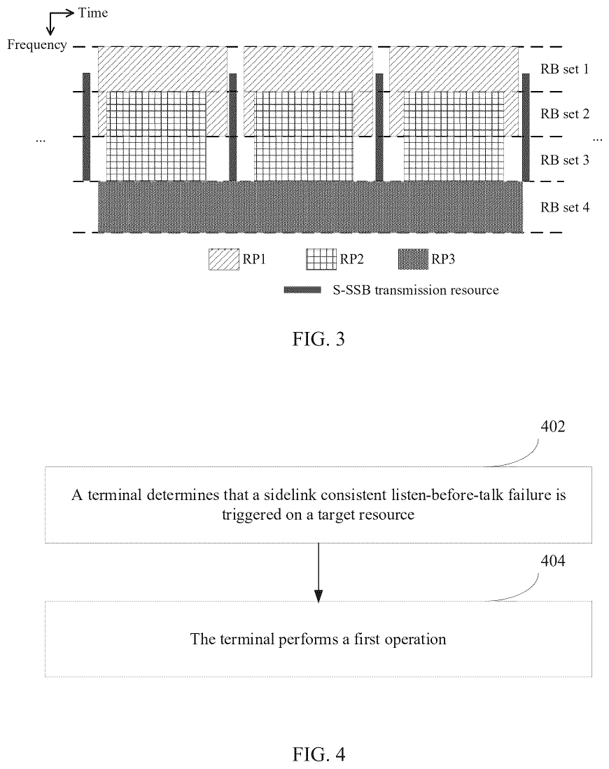

FIG. 3 is a schematic diagram of a structure of an NR sidelink resource according to an embodiment of this application. Due to operating in an unlicensed band, NR operating in the unlicensed band (NR-Unlicensed band, NR-U) and a sidelink operating in the unlicensed band (sidelink-Unlicensed band, SL-U) both support a subband (Subband)-based resource structure, where a subband is a part of an entire bandwidth corresponding to a carrier in the unlicensed band. In the NR-U and SL-U, a subband is referred to as a resource block set (Resource block set, RB set), which corresponds to a set of “time-frequency”resources. Particularly, referring to FIG. 3, for the SL-U, the 3GPP standard currently agrees that one SL-U carrier (carrier) includes only one bandwidth part (BandWidth Part, BWP). Further, one BWP may include one or more resource pools (Resource Pool, RP), and one RP may include one or more RB sets. For example, in FIG. 3, an RP 1 includes an RB set 1 and an RB set 2, an RP 2 includes the RB set 2 and an RB set 3, and an RP 3 includes an RB set 4.

A method and an apparatus for processing a sidelink consistent listen-before-talk failure, and a terminal provided in embodiments of this application are hereinafter described in detail by using some embodiments and application scenarios thereof with reference to the accompanying drawings.

FIG. 4 is a schematic flowchart of a method for processing a sidelink consistent listen-before-talk failure according to an embodiment of this application. The method may be performed by a terminal. Referring to FIG. 4, the method includes the following steps.

Step 402: A terminal determines that a sidelink consistent listen-before-talk failure is triggered on a target resource.

In an implementation, a resource granularity of the target resource may include one of the following:
(1) a resource block (Resource Block, RB) set (set);
(2) a resource pool (Resource pool);
(3) a bandwidth part (Band Width Part, BWP);
(4) a carrier (carrier); and
(5) a carrier frequency (carrier frequency).

In this implementation, the terminal may determine that a sidelink consistent listen-before-talk failure is triggered on one or more RB sets, or that a sidelink consistent listen-before-talk failure is triggered on one or more resource pools, or that a sidelink consistent listen-before-talk failure is triggered on one or more BWPs, or that a sidelink consistent listen-before-talk failure is triggered on one or more carriers, or that a sidelink consistent listen-before-talk failure (SL consistent LBT failure) is triggered on one or more carrier frequencies.

The terminal may perform a listen-before-talk (Listen before talk, LBT) operation for each SL transmission on a target resource. If a channel is busy or unavailable on the target resource, that is, if an LBT failure occurs, it is determined that one LBT failure has been detected on the target resource, and a number of LBT failures detected is counted cumulatively. When the cumulative count of LBT failures for any SL transmission detected by the terminal on the target resource reaches a threshold configured by a network, the terminal determines that a sidelink consistent LBT failure is triggered, and performs step 404.

Step 404: The terminal performs a first operation.

In this embodiment of this application, the first operation includes at least one of the following:
(1) clearing a first sidelink grant resource, where the first sidelink grant resource includes the target resource on which the sidelink consistent listen-before-talk failure has been triggered;
(2) performing resource selection or reselection for the first sidelink grant resource;
(3) performing resource pool reselection; and
(4) canceling the sidelink consistent listen-before-talk failure that has been triggered but has not been canceled on the target resource.

In this embodiment of this application, after determining that the sidelink consistent listen-before-talk failure is triggered on the target resource, the terminal performs the first operation to perform processing, where the first operation may be clearing the first sidelink grant resource, and the first sidelink grant resource includes the target resource on which the sidelink consistent listen-before-talk failure has been triggered. Clearing the target resource on which the sidelink consistent listen-before-talk failure has been triggered can avoid unnecessary clearing of some sidelink grant resources. The first operation may alternatively be performing resource selection or reselection for the first sidelink grant resource, thereby avoiding unnecessary selection or reselection of some sidelink grant resources. The first operation may alternatively be performing resource pool reselection, so that a resource pool meeting a transmission requirement can be selected and that an unnecessary action of performing a sending resource selection/reselection check can be avoided. The first operation may alternatively be canceling the sidelink consistent listen-before-talk failure that has been triggered but has not been canceled on the target resource, thereby avoiding an unnecessary operation of processing the sidelink consistent listen-before-talk failure. According to the technical solutions provided in the embodiments of this application, after the terminal determines that the sidelink consistent listen-before-talk failure is triggered on the target resource, the terminal performs the first operation including at least one of the foregoing, so that the sidelink consistent listen-before-talk failure triggered on the target resource can be processed.

In an implementation, after the terminal determines that the sidelink consistent listen-before-talk failure is triggered on the target resource, that the terminal clears a first sidelink grant resource in the foregoing step 404 may include:

Step 4041: The terminal clears the first sidelink grant resource including the target resource in a target time period, where the target time period is a continuous time period starting from a target time unit or target time, and the target time unit or target time is a time unit or time when it is determined that the sidelink consistent listen-before-talk failure is triggered on the target resource.

The time unit may include a symbol (symbol), a slot (slot), a subframe (subframe), or a frame (frame).

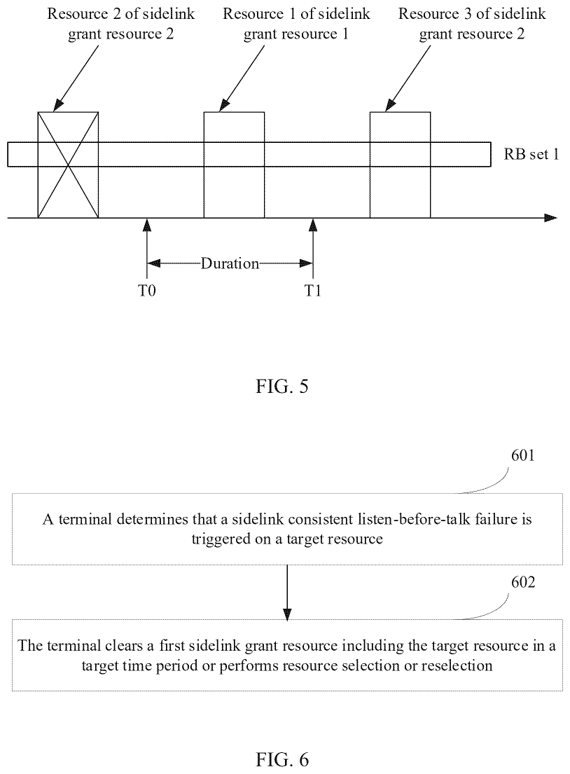

For example, as shown in FIG. 5, at a time unit T0 or time T0, if the terminal determines that a sidelink consistent listen-before-talk failure has been triggered on an RB set 1, for a sidelink grant resource including the RB set 1 in a continuous time period (duration) starting from the time unit T0 or time T0, the terminal clears the sidelink grant resource. In other words, for a sidelink grant resource including the RB set 1 after the continuous time period starting from the time unit T0 or time T0 (that is, after a time unit T1 or time T1), the terminal does not clear the sidelink grant resource. It can be known that the sidelink consistent listen-before-talk failure is triggered on the RB set 1 at the time unit T0 or time T0, which essentially represents that a channel is busy in the continuous time period starting from the time T0, and that it is difficult for the terminal to access the channel by using a grant resource including the RB set 1. However, after the continuous time period, the channel may not be so busy as above. In this case, for a resource after the continuous time period (for example, a resource 3 in a grant resource 2), the terminal may attempt to access the channel by using the resource.

As shown in FIG. 5, both a sidelink grant resource 1 and a sidelink grant resource 2 include the RB set 1. When the sidelink consistent listen-before-talk failure is triggered on the RB set 1 at the time unit T0 or time T0, because a resource 1 (Resource 1) of the sidelink grant resource 1 is in the continuous time period starting from the time T0, the terminal clears the sidelink grant resource 1. For the sidelink grant resource 2, although a sidelink listen-before-talk failure is also triggered on a resource 2 (Resource 2), and a sidelink consistent listen-before-talk failure is also triggered at the time T0 after the sidelink listen-before-talk failure is triggered, because a resource 3 (Resource 3) of the sidelink grant resource 2 is not in the continuous time period starting from the time T0, the terminal does not perform a clear (clear) operation on the sidelink grant resource 2.

In the foregoing implementation, the terminal clears the sidelink grant resource including the target resource on which the sidelink consistent listen-before-talk failure has been triggered in the target time period, but does not clear other sidelink resources, thereby avoiding unnecessary clearing of some sidelink grant resources.

In an implementation, after the terminal determines that the sidelink consistent listen-before-talk failure is triggered on the target resource, that the terminal performs resource selection or reselection for the first sidelink grant resource in the foregoing step 404 may include:

Step 4042: The terminal performs resource selection or reselection for the first sidelink grant resource including the target resource in a target time period, where the target time period is a continuous time period starting from a target time unit or target time, and the target time unit or target time is a time unit or time when it is determined that the sidelink consistent listen-before-talk failure is triggered on the target resource.

In the embodiment of this application, as shown in FIG. 5, at a time unit T0 or time T0, if the UE determines that a sidelink consistent listen-before-talk failure has been triggered on an RB set 1, for a sidelink grant resource including the RB set 1 in a continuous time period (duration) starting from the time unit T0 or time T0, the UE performs resource selection or reselection. In other words, for a sidelink grant resource including the RB set 1 after the continuous time period starting from the time unit T0 or time T0 (that is, after a time unit T1 or time T1), the UE does not perform resource selection or reselection.

As shown in FIG. 5, both a sidelink grant resource 1 and a sidelink grant resource 2 include the RB set 1. When the sidelink consistent listen-before-talk failure is triggered on the RB set 1 at the time unit T0 or time T0, because a resource 1 (Resource 1) of the sidelink grant resource 1 is in the continuous time period starting from the time T0, the UE performs resource selection or reselection for the sidelink grant resource 1. For the sidelink grant resource 2, although a sidelink listen-before-talk failure is also triggered on a resource 2 (Resource 2), and a sidelink consistent listen-before-talk failure is also triggered at the time T0 after the sidelink listen-before-talk failure is triggered, because a resource 3 (Resource 3) of the sidelink grant resource 2 is not in the continuous time period starting from the time T0, the UE does not perform resource selection or reselection for the sidelink grant resource 2.

In the foregoing implementation, the terminal selects or reselects the sidelink grant resource including the target resource on which the sidelink consistent listen-before-talk failure has been triggered in the target time period, thereby avoiding unnecessary selection or reselection of some sidelink grant resources.

In an implementation, a duration of the continuous time period may be determined based on at least one of the following:
(1) a value M configured by a network side or specified by a protocol, where for example, the duration of the continuous time period configured by the network side or specified by the protocol is M symbols (symbol), slots (slot), subframes (subframe), or frames (frame), where M may be an integer greater than 0, or may be a decimal greater than 0, which is not limited in this embodiment of this application; and
(2) a duration N of a target timer configured by the network side or specified by a protocol, where for example, the UE may determine that the duration of the continuous time period is equal to the duration N or to the duration N multiplied by n, where n may be an integer greater than 0, or may be a decimal greater than 0, which is not limited in this embodiment of this application.

In the foregoing implementation, the duration of the continuous time period is configured by the network side, so that the sidelink grant resource cleared, selected, or reselected by the terminal can meet a requirement of the network side.

Optionally, the target timer may be one of the following:
(1) a timer for the terminal to determine recovery of the target resource from the sidelink consistent listen-before-talk failure; and
(2) a timer for the terminal to cancel the sidelink consistent listen-before-talk failure.

In an implementation, the method for processing a sidelink consistent listen-before-talk failure may further include: the terminal continuously performs a sending resource selection or reselection check until the terminal triggers resource pool reselection. In this implementation, after triggering resource pool reselection, the terminal stops continuously performing the sending resource selection or reselection check, thereby avoiding an unnecessary sending resource selection or reselection check action.

That the terminal triggers resource pool reselection may include: the terminal triggers resource pool reselection in a case that it is determined that the sidelink consistent listen-before-talk failure is triggered.

In embodiments of this application, in a process of creating a sidelink grant resource, the UE needs to first select a resource pool, and then needs to continuously perform a sending resource selection or reselection check until the resource pool currently selected by the UE is released via radio resource control (Radio Resource Control, RRC), or a MAC entity determines to cancel creation of a sidelink grant resource for transmitting a plurality of MAC protocol data units (protocol data unit, PDU).

If the UE performs resource pool reselection, the UE temporarily does not use the currently selected resource pool. Therefore, the UE continuously performs the sending resource selection or reselection check until the UE triggers resource pool reselection. Optionally, because the UE has triggered the sidelink consistent listen-before-talk failure, the UE triggers resource pool reselection.

In other words, if the UE triggers resource pool reselection because the UE has triggered the sidelink consistent listen-before-talk failure, the UE stops performing the sending resource selection or reselection check for the currently selected resource pool; or it may be understood that the UE stops performing the sending resource selection or reselection check for the currently selected resource pool before reselecting a resource pool.

In the foregoing implementation, the terminal may stop performing the sending resource selection or reselection check for the currently selected resource pool in a case that resource pool reselection is triggered, thereby avoiding an unnecessary sending resource selection or reselection check.

In an implementation, after the terminal determines that the sidelink consistent listen-before-talk failure is triggered on the target resource, that the terminal performs resource pool reselection in the foregoing step 404 may include:

Step 4043: In a case that it is determined that the sidelink consistent listen-before-talk failure is triggered on the target resource, or resource pool reselection is triggered, or clearing, or resource selection or reselection is performed for the first sidelink grant resource, the terminal performs corresponding resource pool reselection based on a type of a target logical channel associated with a target object, where the target object includes one of the following associated with the first sidelink grant resource: a sidelink process (SL process), a transport block (Transport Block, TB), and a MAC PDU.

In this implementation, the terminal may perform corresponding resource pool reselection based on a type of a logical channel associated with a target object associated with the first sidelink grant resource, so that the terminal can select a resource pool meeting a transmission requirement.

In an implementation, that the terminal performs corresponding resource pool reselection based on a type of a target logical channel associated with a target object in the foregoing step 4043 may include: in a case that the target logical channel is a logical channel for transmitting a sidelink discovery signal, where for example, for an SL process, TB, or MAC PDU associated with a first SL grant, the logical channel associated with the SL process, TB, or MAC PDU is used for NR SL discovery, the terminal performs at least one of the following:
(1) The terminal performs resource pool reselection to a first resource pool, where the first resource pool is a discovery resource pool including a resource block set on which no sidelink consistent listen-before-talk failure has been triggered.

The discovery resource pool may be at least one discovery resource pool indicated by SL-DiscTxPoolSelected configured in a sidelink bandwidth part discovery resource pool configuration (SL-BWP-DiscPoolConfig) or a sidelink bandwidth part discovery resource pool common configuration (SL-BWP-DiscPoolConfigCommon).
(2) In a case that there is no discovery resource pool including a resource block set on which no sidelink consistent listen-before-talk failure has been triggered, the terminal terminates resource pool reselection.

That the terminal terminates resource pool reselection may be that the terminal does not reselect another resource pool different from the currently selected resource pool, or that the terminal continues to use the currently selected resource pool.
(3) In a case that there is no discovery resource pool including a resource block set on which no sidelink consistent listen-before-talk failure has been triggered, the terminal performs resource pool reselection to a second resource pool, where the second resource pool is a resource pool other than a discovery resource pool, and the second resource pool includes a resource block set on which no sidelink consistent listen-before-talk failure has been triggered.

Optionally, the discovery resource pool may be at least one discovery resource pool indicated by a sidelink discovery signal transmission resource pool selection parameter configured in a sidelink bandwidth part discovery resource pool configuration. For example, the discovery resource pool is at least one discovery resource pool indicated by SL-DiscTxPoolSelected configured in SL-BWP-DiscPoolConfig or SL-BWP-DiscPoolConfigCommon.

Optionally, the second resource pool reselected by the terminal may include an RB set on which no sidelink consistent listen-before-talk failure has been triggered.
(4) In a case that there is no resource pool including a resource block set on which no sidelink consistent listen-before-talk failure has been triggered, the terminal terminates resource pool reselection.

That the terminal terminates resource pool reselection may be that the terminal does not reselect another resource pool different from the currently selected resource pool, or that the terminal continues to use the currently selected resource pool.
(5) In a case that there is no resource pool including a resource block set on which no sidelink consistent listen-before-talk failure has been triggered, the terminal performs resource pool reselection to an exceptional resource pool.

In this embodiment of this application, for the sidelink process, TB, or MAC PDU currently associated with the sidelink grant resource, if the logical channel associated with the sidelink process, TB, or MAC PDU is the logical channel for transmitting the sidelink discovery signal, the terminal performs at least one of the foregoing, so that after the sidelink consistent listen-before-talk failure is triggered, the terminal reselects a resource pool meeting a transmission requirement.

In an implementation, that the terminal performs corresponding resource pool reselection based on a type of a target logical channel associated with a target object in the foregoing step 4043 may include: in a case that sidelink feedback of the target logical channel is enabled, where for example, for the SL process, TB, or MAC PDU associated with the first SL grant, an sl-HARQ-FeedbackEnabled field of the logical channel associated with the SL process, TB, or MAC PDU is set to “enabled”, the terminal performs at least one of the following:
(1) The terminal performs resource pool reselection to a third resource pool configured with a PSFCH resource, where the third resource pool includes a resource block set on which no sidelink consistent listen-before-talk failure has been triggered.

Optionally, the third resource pool may include a normal resource pool (normal pool) or an exceptional resource pool (exceptional pool).

Optionally, the terminal preferentially reselects the normal resource pool configured with a PSFCH resource.
(2) In a case that there is no resource pool configured with a PSFCH resource and including a resource block set on which no sidelink consistent listen-before-talk failure has been triggered, the terminal terminates resource pool reselection.

That the terminal terminates resource pool reselection may be that the terminal does not reselect another resource pool different from the currently selected resource pool, or that the terminal continues to use the currently selected resource pool.
(3) In a case that there is no resource pool configured with a PSFCH resource and including a resource block set on which no sidelink consistent listen-before-talk failure has been triggered, the terminal performs resource pool reselection to an exceptional resource pool.

The resource pool configured with the PSFCH resource includes a normal resource pool.

In this embodiment of this application, for the sidelink process, TB, or MAC PDU currently associated with the sidelink grant resource, if an SL-HARQ-FeedbackEnabled field of the logical channel associated with the sidelink process, TB, or MAC PDU is set to “enabled”, the terminal performs at least one of the foregoing, so that after the sidelink consistent listen-before-talk failure is triggered, the terminal reselects a resource pool meeting a transmission requirement.

In an implementation, that the terminal performs corresponding resource pool reselection based on a type of a target logical channel associated with a target object in the foregoing step 4043 may include:

In a case that sidelink feedback of the target logical channel is not enabled or that the target logical channel is not a logical channel for transmitting a sidelink discovery signal, the terminal performs at least one of the following:
(1) The terminal performs resource pool reselection to any fourth resource pool including a resource block set on which no sidelink consistent listen-before-talk failure has been triggered.

Optionally, the fourth resource pool may include a normal resource pool or an exceptional resource pool.

Optionally, the terminal preferentially reselects the fourth resource pool configured with a PSFCH resource.
(2) In a case that there is no resource pool including a resource block set on which no sidelink consistent listen-before-talk failure has been triggered, the terminal terminates resource pool reselection.

That the terminal terminates resource pool reselection may be that the terminal does not reselect another resource pool different from the currently selected resource pool, or that the terminal continues to use the currently selected resource pool.

In this embodiment of this application, for the sidelink process, TB, or MAC PDU currently associated with the sidelink grant resource, for other types of logical channels associated with the sidelink process, TB, or MAC PDU, that is, if the logical channel associated with the sidelink process, TB, or MAC PDU is not a logical channel for transmitting a sidelink discovery signal, and an SL-HARQ-FeedbackEnabled field of the logical channel associated with the sidelink process, TB, or MAC PDU is not set to “enabled”, the terminal performs at least one of the foregoing, so that after the sidelink consistent listen-before-talk failure is triggered, the terminal reselects a resource pool meeting a transmission requirement.

In an implementation, after the terminal determines that the sidelink consistent listen-before-talk failure is triggered on the target resource, that the terminal cancels the sidelink consistent listen-before-talk failure that has been triggered but has not been canceled on the target resource in the foregoing step 404 may include: Step 4044: In a case that at least one of the following is met, the terminal cancels the sidelink consistent listen-before-talk failure that has been triggered but has not been canceled on the target resource:
(1) a resource pool including the target resource is released;
(2) the terminal enters a radio resource control RRC idle mode (RRC Idle mode) or an RRC inactive mode (RRC Inactive mode) from an RRC connected mode (RRC Connected mode); and
(3) the terminal enters the RRC connected mode from the RRC idle mode or the RRC inactive mode.

In this embodiment of this application, after the terminal determines that the sidelink consistent listen-before-talk failure is triggered on the target resource, in a case that at least one of the foregoing (1), (2), and (3) is met, the terminal cancels the sidelink consistent listen-before-talk failure that has been triggered but has not been canceled on the target resource, thereby avoiding unnecessary processing of a sidelink consistent listen-before-talk failure.

To describe in detail the method for processing a sidelink consistent listen-before-talk failure according to the embodiments of this application, the following describes several specific embodiments.

### Embodiment 1

This embodiment shows a procedure for clearing a first sidelink grant resource or performing resource selection or reselection for a first sidelink grant resource after a terminal determines that a sidelink consistent listen-before-talk failure is triggered on a target resource. As shown in FIG. 6, an execution procedure of this embodiment is as follows:

Step 601: A terminal determines that a sidelink consistent listen-before-talk failure is triggered on a target resource.

For example, in a case that the target resource is an SL RB set, the terminal may record a cumulative count of LBT failures that occur on each SL RB set, to determine that a sidelink consistent listen-before-talk failure is triggered. When a cumulative count of LBT failures for any SL transmission detected by the terminal reaches a threshold configured by a network or specified by a protocol, the terminal determines that a consistent LBT failure is triggered.

Step 602: The terminal clears a first sidelink grant resource including the target resource in a target time period or performs resource selection or reselection.

Optionally, the target time period may be determined based on at least one of the following:
(1) a value M configured by a network side or specified by a protocol; and
(2) a duration N of a target timer configured by the network side or specified by a protocol.

Optionally, the target timer is one of the following:
(1) a timer for the terminal to determine recovery of the target resource from the sidelink consistent listen-before-talk failure; and
(2) a timer for the terminal to cancel the sidelink consistent listen-before-talk failure.

### Embodiment 2

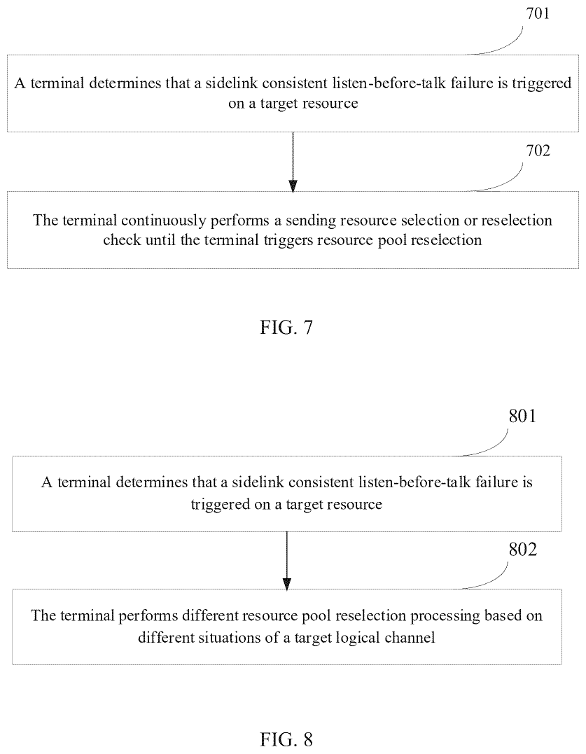

This embodiment shows a procedure for performing a sending resource selection or reselection check after a terminal triggers a sidelink consistent listen-before-talk failure. As shown in FIG. 7, an execution procedure of this embodiment is as follows:

Step 701: A terminal determines that a sidelink consistent listen-before-talk failure is triggered on a target resource.

For example, in a case that the target resource is an SL RB set, the terminal may record a cumulative count of LBT failures that occur on each SL RB set, to determine that a sidelink consistent listen-before-talk failure is triggered. When a cumulative count of LBT failures for any SL transmission detected by the terminal reaches a threshold configured by a network or specified by a protocol, the terminal determines that a consistent LBT failure is triggered.

Step 702: The terminal continuously performs a sending resource selection or reselection check until the terminal triggers resource pool reselection.

Step 702 may be understood as follows: If the terminal triggers resource pool reselection because the terminal triggers the sidelink consistent listen-before-talk failure, the terminal stops performing the sending resource selection or reselection check for a currently selected resource pool. Alternatively, step 702 may be understood as follows: The terminal stops performing the sending resource selection or reselection check for a currently selected resource pool before reselecting a resource pool.

### Embodiment 3

This embodiment shows a procedure for performing resource pool reselection after a terminal determines that a sidelink consistent listen-before-talk failure is triggered on a target resource. As shown in FIG. 8, an execution procedure of this embodiment is as follows:

Step 801: A terminal determines that a sidelink consistent listen-before-talk failure is triggered on a target resource.

For example, in a case that the target resource is an SL RB set, the terminal may record a cumulative count of LBT failures that occur on each SL RB set, to determine that a sidelink consistent listen-before-talk failure is triggered. When a cumulative count of LBT failures for any SL transmission detected by the terminal reaches a threshold configured by a network or specified by a protocol, the terminal determines that a consistent LBT failure is triggered.

Step 802: The terminal performs different resource pool reselection processing based on different situations of a target logical channel. For specific processing steps, refer to the following steps 8021 to 8023.

Step 8021: In a case that the target logical channel is a logical channel for transmitting a sidelink discovery signal, the terminal performs at least one of the following (1) to (5):
(1) The terminal performs resource pool reselection to a first resource pool, where the first resource pool is a discovery resource pool including a resource block set on which no sidelink consistent listen-before-talk failure has been triggered.

Optionally, the discovery resource pool is at least one discovery resource pool indicated by SL-DiscTxPoolSelected configured in a sidelink bandwidth part discovery resource pool configuration (SL-BWP-DiscPoolConfig) or a sidelink bandwidth part discovery resource pool common configuration (SL-BWP-DiscPoolConfigCommon).
(2) In a case that there is no discovery resource pool including a resource block set on which no sidelink consistent listen-before-talk failure has been triggered, the terminal terminates resource pool reselection.

That the terminal terminates resource pool reselection may be that the terminal does not reselect another resource pool different from the currently selected resource pool, or that the terminal continues to use the currently selected resource pool.
(3) In a case that there is no discovery resource pool including a resource block set on which no sidelink consistent listen-before-talk failure has been triggered, the terminal performs resource pool reselection to a second resource pool, where the second resource pool is a resource pool other than a discovery resource pool, and the second resource pool includes a resource block set on which no sidelink consistent listen-before-talk failure has been triggered.

Optionally, the discovery resource pool is at least one discovery resource pool indicated by a sidelink discovery signal transmission resource pool selection parameter configured in a sidelink bandwidth part discovery resource pool configuration. In other words, the discovery resource pool is at least one discovery resource pool indicated by SL-DiscTxPoolSelected configured in SL-BWP-DiscPoolConfig or SL-BWP-DiscPoolConfigCommon.

Optionally, the second resource pool reselected by the terminal may include an RB set on which no sidelink consistent listen-before-talk failure has been triggered.
(4) In a case that there is no resource pool including a resource block set on which no sidelink consistent listen-before-talk failure has been triggered, the terminal terminates resource pool reselection.

That the terminal terminates resource pool reselection may be that the terminal does not reselect another resource pool different from the currently selected resource pool, or that the terminal continues to use the currently selected resource pool.
(5) In a case that there is no resource pool including a resource block set on which no sidelink consistent listen-before-talk failure has been triggered, the terminal performs resource pool reselection to an exceptional resource pool.

Step 8022: In a case that sidelink feedback of the target logical channel is enabled, the terminal performs at least one of the following (1) to (3):
(1) The terminal performs resource pool reselection to a third resource pool configured with a PSFCH resource, where the third resource pool includes a resource block set on which no sidelink consistent listen-before-talk failure has been triggered.

Optionally, the third resource pool may include a normal resource pool or an exceptional resource pool.

Optionally, the terminal preferentially reselects the normal resource pool configured with a PSFCH resource.
(2) In a case that there is no resource pool configured with a PSFCH resource and including a resource block set on which no sidelink consistent listen-before-talk failure has been triggered, the terminal terminates resource pool reselection.

That the terminal terminates resource pool reselection may be that the terminal does not reselect another resource pool different from the currently selected resource pool, or that the terminal continues to use the currently selected resource pool.
(3) In a case that there is no resource pool configured with a PSFCH resource and including a resource block set on which no sidelink consistent listen-before-talk failure has been triggered, the terminal performs resource pool reselection to an exceptional resource pool.

The resource pool configured with the PSFCH resource includes a normal resource pool.

Step 8023: In a case that sidelink feedback of the target logical channel is not enabled or that the target logical channel is not a logical channel for transmitting a sidelink discovery signal, the terminal performs at least one of the following:
(1) The terminal performs resource pool reselection to any fourth resource pool including a resource block set on which no sidelink consistent listen-before-talk failure has been triggered.

Optionally, the fourth resource pool may include a normal resource pool or an exceptional resource pool.

Optionally, the terminal preferentially reselects the fourth resource pool configured with a PSFCH resource.
(2) In a case that there is no resource pool including a resource block set on which no sidelink consistent listen-before-talk failure has been triggered, the terminal terminates resource pool reselection.

That the terminal terminates resource pool reselection may be that the terminal does not reselect another resource pool different from the currently selected resource pool, or that the terminal continues to use the currently selected resource pool.

### Embodiment 4

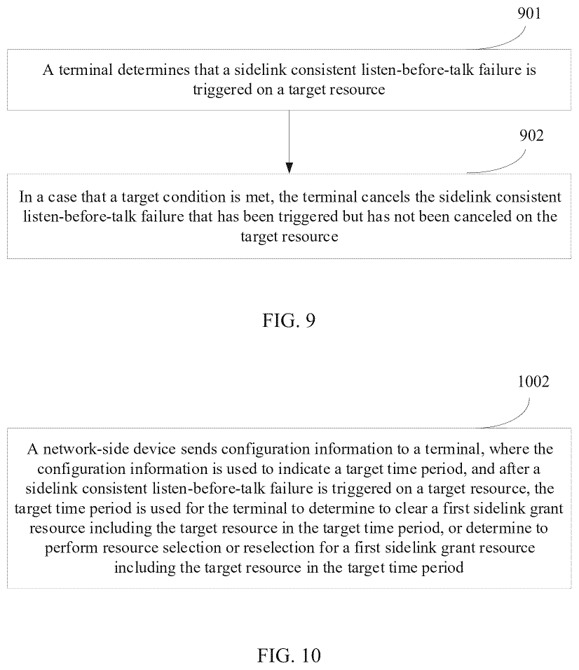

This embodiment shows a procedure for canceling a sidelink consistent listen-before-talk failure after a terminal determines that the sidelink consistent listen-before-talk failure is triggered on a target resource. As shown in FIG. 9, an execution procedure of this embodiment is as follows:

Step 901: A terminal determines that a sidelink consistent listen-before-talk failure is triggered on a target resource.

For example, in a case that the target resource is an SL RB set, the terminal may record a cumulative count of LBT failures that occur on each SL RB set, to determine that a sidelink consistent listen-before-talk failure is triggered. When a cumulative count of LBT failures for any SL transmission detected by the terminal reaches a threshold configured by a network or specified by a protocol, the terminal determines that a consistent LBT failure is triggered.

Step 902: In a case that a target condition is met, the terminal cancels the sidelink consistent listen-before-talk failure that has been triggered but has not been canceled on the target resource.

The target condition includes at least one of the following:
(1) a resource pool including the target resource is released;
(2) the terminal enters a radio resource control (RRC) idle mode or an RRC inactive mode from an RRC connected mode; and
(3) the terminal enters the RRC connected mode from the RRC idle mode or the RRC inactive mode.

The method for processing a sidelink consistent listen-before-talk failure according to the embodiments of this application may be performed by an apparatus for processing a sidelink consistent listen-before-talk failure. An apparatus for processing a sidelink consistent listen-before-talk failure according to the embodiments of this application is described by assuming that the method for processing a sidelink consistent listen-before-talk failure in the embodiments of this application is performed by the apparatus for processing a sidelink consistent listen-before-talk failure.

FIG. 10 is a schematic flowchart of a method for configuring a sidelink consistent listen-before-talk failure according to an embodiment of this application. The method may be performed by a network-side device. Referring to FIG. 10, the method may include the following step.

Step 1002: A network-side device sends configuration information to a terminal, where the configuration information is used to indicate a target time period, and after a sidelink consistent listen-before-talk failure is triggered on a target resource, the target time period is used for the terminal to determine to clear a first sidelink grant resource including the target resource in the target time period, or determine to perform resource selection or reselection for a first sidelink grant resource including the target resource in the target time period.

In this embodiment of this application, the network-side device sends the configuration information indicating the target time period to the terminal, so that after the sidelink consistent listen-before-talk failure is triggered on the target resource, the terminal can clear the first sidelink grant resource including the target resource in the target time period, or determine to perform resource selection or reselection for the first sidelink grant resource including the target resource in the target time period. Therefore, the terminal can clear the sidelink grant resource including the target resource on which the sidelink consistent listen-before-talk failure is triggered in the target time period, thereby avoiding unnecessary selection or reselection of some sidelink grant resources; or the terminal selects or reselects the sidelink grant resource including the target resource on which the sidelink consistent listen-before-talk failure is triggered in the target time period, thereby avoiding unnecessary selection or reselection of some sidelink grant resources.

In an implementation, the configuration information includes one of the following:
first indication information, used to indicate a value M, where for example, the network-side device directly configures a duration, indicating that after the duration following the triggering of the sidelink consistent listen-before-talk failure, the terminal can clear, select, or reselect the sidelink grant resource including the target resource on which the sidelink consistent listen-before-talk failure is triggered; and
second indication information, used to indicate a duration N of a target timer, where the network-side device configures the duration N of the target timer, indicating that after a continuous time period following the triggering of the sidelink consistent listen-before-talk failure, the terminal can clear, select, or reselect, based on the duration N of the target timer, the sidelink grant resource including the target resource on which the sidelink consistent listen-before-talk failure is triggered; for example, after the duration N of the target timer, the terminal clears, selects, or reselects the sidelink grant resource including the target resource on which the sidelink consistent listen-before-talk failure is triggered.

Optionally, the target timer includes one of the following:
(1) a timer for the terminal to determine recovery of the target resource from the sidelink consistent listen-before-talk failure; and
(2) a timer for the terminal to cancel the sidelink consistent listen-before-talk failure.

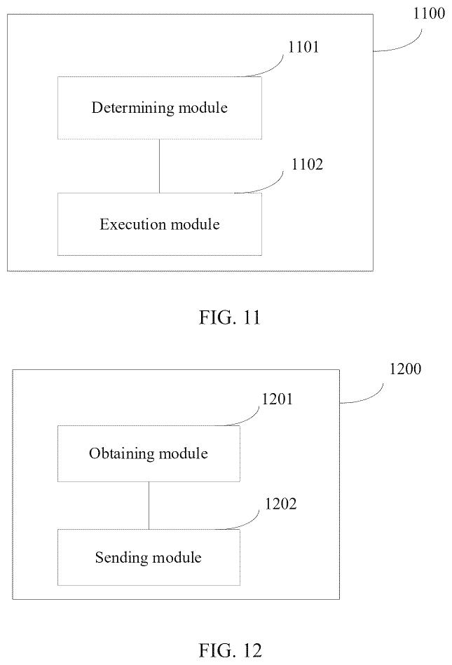

FIG. 11 is a schematic diagram of an apparatus for processing a sidelink consistent listen-before-talk failure according to an embodiment of this application. Referring to FIG. 11, the apparatus 1100 may include a determining module 1101 and an execution module 1102.

The determining module 1101 is configured to determine that a sidelink consistent listen-before-talk failure is triggered on a target resource; and the execution module 1102 is configured to perform a first operation, where the first operation includes at least one of the following:
(1) clearing a first sidelink grant resource, where the first sidelink grant resource includes the target resource on which the sidelink consistent listen-before-talk failure has been triggered;
(2) performing resource selection or reselection for the first sidelink grant resource;
(3) performing resource pool reselection; and
(4) canceling the sidelink consistent listen-before-talk failure that has been triggered but has not been canceled on the target resource.

In an implementation, a resource granularity of the target resource includes one of the following:
(1) a resource block set;
(2) a resource pool;
(3) a bandwidth part;
(4) a carrier; and
(5) a carrier frequency.

In an implementation, the clearing, by the execution module 1102, a first sidelink grant resource includes: clearing the first sidelink grant resource including the target resource in a target time period, where the target time period is a continuous time period starting from a target time unit or target time, and the target time unit or target time is a time unit or time when it is determined that the sidelink consistent listen-before-talk failure is triggered on the target resource.

In an implementation, the performing, by the execution module 1102, resource selection or reselection for the first sidelink grant resource includes: performing resource selection or reselection for the first sidelink grant resource including the target resource in a target time period, where the target time period is a continuous time period starting from a target time unit or target time, and the target time unit or target time is a time unit or time when it is determined that the sidelink consistent listen-before-talk failure is triggered on the target resource.

In an implementation, a duration of the continuous time period is determined based on at least one of the following:
(1) a value M configured by a network side or specified by a protocol; and
(2) a duration N of a target timer configured by the network side or specified by a protocol.

In an implementation, the target timer is one of the following:
(1) a timer for determining recovery of the target resource from the sidelink consistent listen-before-talk failure; and
(2) a timer for canceling the sidelink consistent listen-before-talk failure.

In an implementation, the execution module 1102 may be further configured to continuously perform a sending resource selection or reselection check until resource pool reselection is triggered.

In an implementation, the performing, by the execution module 1102, resource pool reselection includes: in a case that it is determined that the sidelink consistent listen-before-talk failure is triggered on the target resource, or resource pool reselection is triggered, or clearing, or resource selection or reselection is performed for the first sidelink grant resource, performing corresponding resource pool reselection based on a type of a target logical channel associated with a target object, where the target object includes one of the following associated with the first sidelink grant resource: a sidelink process, a transport block (TB), and a media access control (MAC) protocol data unit (PDU).

In an implementation, the performing, by the execution module 1102, corresponding resource pool reselection based on a type of a target logical channel associated with a target object includes: in a case that the target logical channel is a logical channel for transmitting a sidelink discovery signal, performing at least one of the following:
(1) performing resource pool reselection to a first resource pool, where the first resource pool is a discovery resource pool including a resource block set on which no sidelink consistent listen-before-talk failure has been triggered;
(2) in a case that there is no discovery resource pool including a resource block set on which no sidelink consistent listen-before-talk failure has been triggered, terminating resource pool reselection;
(3) in a case that there is no discovery resource pool including a resource block set on which no sidelink consistent listen-before-talk failure has been triggered, performing resource pool reselection to a second resource pool, where the second resource pool is a resource pool other than a discovery resource pool, and the second resource pool includes a resource block set on which no sidelink consistent listen-before-talk failure has been triggered;
(4) in a case that there is no resource pool including a resource block set on which no sidelink consistent listen-before-talk failure has been triggered, terminating resource pool reselection; and
(5) in a case that there is no resource pool including a resource block set on which no sidelink consistent listen-before-talk failure has been triggered, performing resource pool reselection to an exceptional resource pool.

In an implementation, the discovery resource pool is at least one discovery resource pool indicated by a sidelink discovery signal transmission resource pool selection parameter configured in a sidelink bandwidth part discovery resource pool configuration.

In an implementation, the performing, by the execution module 1102, corresponding resource pool reselection based on a type of a target logical channel associated with a target object includes: in a case that sidelink feedback of the target logical channel is enabled, performing at least one of the following:
(1) performing resource pool reselection to a third resource pool configured with a physical sidelink feedback channel PSFCH resource, where the third resource pool includes a resource block set on which no sidelink consistent listen-before-talk failure has been triggered;
(2) in a case that there is no resource pool configured with a PSFCH resource and including a resource block set on which no sidelink consistent listen-before-talk failure has been triggered, terminating resource pool reselection; and
(3) in a case that there is no resource pool configured with a PSFCH resource and including a resource block set on which no sidelink consistent listen-before-talk failure has been triggered, performing resource pool reselection to an exceptional resource pool.

In an implementation, the performing, by the execution module 1102, corresponding resource pool reselection based on a type of a target logical channel associated with a target object includes: in a case that sidelink feedback of the target logical channel is not enabled or that the target logical channel is not a logical channel for transmitting a sidelink discovery signal, performing at least one of the following:
(1) performing resource pool reselection to any fourth resource pool including a resource block set on which no sidelink consistent listen-before-talk failure has been triggered; and
(2) in a case that there is no resource pool including a resource block set on which no sidelink consistent listen-before-talk failure has been triggered, terminating resource pool reselection.

In an implementation, the fourth resource pool includes a normal resource pool or an exceptional resource pool.

In an implementation, the performing, by the execution module 1102, resource pool reselection to any fourth resource pool including a resource block set on which no sidelink consistent listen-before-talk failure has been triggered includes: preferentially reselecting the fourth resource pool configured with a PSFCH resource.

In an implementation, the canceling, by the execution module 1102, the sidelink consistent listen-before-talk failure that has been triggered but has not been canceled on the target resource includes: in a case that at least one of the following is met, canceling the sidelink consistent listen-before-talk failure that has been triggered but has not been canceled on the target resource:
(1) a resource pool including the target resource is released;
(2) the apparatus enters a radio resource control RRC idle mode or an RRC inactive mode from an RRC connected mode; and
(3) the apparatus enters the RRC connected mode from the RRC idle mode or the RRC inactive mode.

The apparatus for processing a sidelink consistent listen-before-talk failure in this embodiment of this application may be an electronic device, for example, an electronic device with an operating system, or may be a component in an electronic device, for example, an integrated circuit or a chip. The electronic device may be a terminal, or may be other devices than a terminal. For example, the terminal may include but is not limited to the foregoing illustrated type of the terminal 11. The other devices may be a server, a network attached storage (Network Attached Storage, NAS), and the like. This is not specifically limited in this embodiment of this application.

The apparatus for processing a sidelink consistent listen-before-talk failure according to this embodiment of this application can implement each process implemented in the method embodiments in FIG. 4 to FIG. 9, with the same technical effect achieved. To avoid repetition, details are not described herein again.

FIG. 12 is a schematic diagram of an apparatus for configuring a sidelink consistent listen-before-talk failure according to an embodiment of this application. Referring to FIG. 12, the apparatus 1200 may include an obtaining module 1201 and a sending module 1202.

In this embodiment of this application, the obtaining module 1201 is configured to obtain configuration information of a terminal, where the configuration information is used to indicate a target time period, and after a sidelink consistent listen-before-talk failure is triggered on a target resource, the target time period is used for the terminal to determine to clear a first sidelink grant resource including the target resource in the target time period, or determine to perform resource selection or reselection for a first sidelink grant resource including the target resource in the target time period; and the sending module 1202 is configured to send the configuration information to the terminal.

In an implementation, the configuration information includes one of the following:
first indication information, used to indicate a value M; and
second indication information, used to indicate a duration N of a target timer.

In an implementation, the target timer includes one of the following:
a timer for the terminal to determine recovery of the target resource from the sidelink consistent listen-before-talk failure; and
a timer for the terminal to cancel the sidelink consistent listen-before-talk failure.

The apparatus for configuring a sidelink consistent listen-before-talk failure according to this embodiment of this application can implement each process implemented in the method embodiment in FIG. 10, with the same technical effect achieved. To avoid repetition, details are not described herein again.

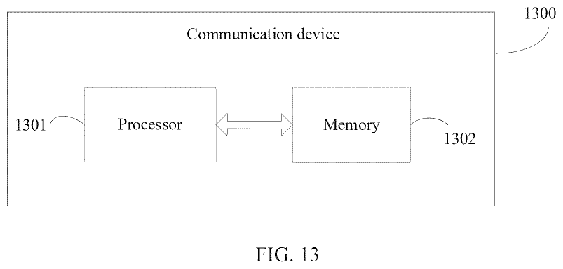

As shown in FIG. 13, an embodiment of this application further provides a communication device 1300, including a processor 1301 and a memory 1302. The memory 1302 stores a program or instructions capable of running on the processor 1301. For example, when the communication device 1300 is a terminal, and the program or instructions are executed by the processor 1301, the steps of the foregoing embodiment of the method for processing a sidelink consistent listen-before-talk failure are implemented; or when the communication device 1300 is a network-side device, and the program or instructions are executed by the processor 1301, the steps of the foregoing embodiment of the method for configuring a sidelink consistent listen-before-talk failure are implemented, with the same technical effect achieved. To avoid repetition, details are not described herein again.

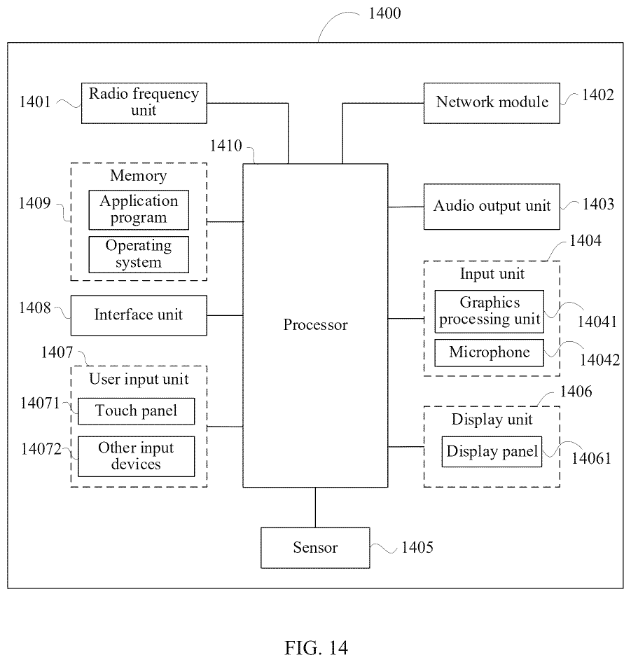

An embodiment of this application further provides a terminal, including a processor and a communication interface. The communication interface is coupled to the processor. The processor is configured to run a program or instructions to implement the steps in the method embodiments in FIG. 4 to FIG. 9. The terminal embodiment corresponds to the foregoing terminal-side method embodiment, and each implementation process and implementation of the foregoing method embodiment can be applied to the terminal embodiment, with the same technical effect achieved. Specifically, FIG. 14 is a schematic diagram of a hardware structure of a terminal for implementing an embodiment of this application.

The terminal 1400 includes but is not limited to at least some components such as a radio frequency unit 1401, a network module 1402, an audio output unit 1403, an input unit 1404, a sensor 1405, a display unit 1406, a user input unit 1407, an interface unit 1408, a memory 1409, and a processor 1410.

A person skilled in the art may understand that the terminal 1400 may further include a power supply (for example, a battery) supplying power to all components. The power supply may be logically connected to the processor 1410 through a power management system. In this way, functions such as charge management, discharge management, and power consumption management are implemented by using the power management system. The terminal structure shown in FIG. 14 does not constitute a limitation on the terminal. The terminal may include more or fewer components than those shown in the figure, or some components are combined, or component arrangements are different. Details are not described herein again.

It should be understood that, in this embodiment of this application, the input unit 1404 may include a graphics processing unit (Graphics Processing Unit, GPU) 14041 and a microphone 14042. The graphics processing unit 14041 processes image data of a still picture or video obtained by an image capture apparatus (such as a camera) in a video capture mode or an image capture mode. The display unit 1406 may include a display panel 14061, and the display panel 14061 may be configured in a form of a liquid crystal display, an organic light-emitting diode, or the like. The user input unit 1407 includes at least one of a touch panel 14071 and other input devices 14072. The touch panel 14071 is also referred to as a touchscreen. The touch panel 14071 may include two parts: a touch detection apparatus and a touch controller. The other input devices 14072 may include but are not limited to a physical keyboard, a function button (such as a volume control button or a power button), a trackball, a mouse, and a joystick. Details are not described herein again.

In this embodiment of this application, after receiving downlink data from a network-side device, the radio frequency unit 1401 may transmit the downlink data to the processor 1410 for processing. In addition, the radio frequency unit 1401 may send uplink data to the network-side device. Usually, the radio frequency unit 1401 includes but is not limited to an antenna, an amplifier, a transceiver, a coupler, a low noise amplifier, a duplexer, and the like.

The memory 1409 may be configured to store software programs or instructions and various data. The memory 1409 may primarily include a first storage area for storing programs or instructions and a second storage area for storing data. The first storage area may store an operating system, an application program or instructions required by at least one function (such as an audio play function and an image play function), and the like. In addition, the memory 1409 may include a volatile memory or a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synch Link DRAM, SLDRAM), and a direct rambus random access memory (Direct Rambus RAM, DRRAM). The memory 1409 in this embodiment of this application includes but is not limited to these and any other suitable types of memories.

The processor 1410 may include one or more processing units. Optionally, the processor 1410 integrates an application processor and a modem processor. The application processor mainly processes operations related to the operating system, a user interface, an application program, and the like. The modem processor mainly processes a wireless communication signal. For example, the modem processor is a baseband processor. It may be understood that the modem processor may alternatively not be integrated in the processor 1410.

The processor 1410 is configured to:
determine that a sidelink consistent listen-before-talk failure is triggered on a target resource; and
perform a first operation, where:
the first operation includes at least one of the following:
clearing a first sidelink grant resource, where the first sidelink grant resource includes the target resource on which the sidelink consistent listen-before-talk failure has been triggered;
performing resource selection or reselection for the first sidelink grant resource;
performing resource pool reselection; and
canceling the sidelink consistent listen-before-talk failure that has been triggered but has not been canceled on the target resource.

It may be understood that for the implementation process of each implementation in this embodiment, reference may be made to the related descriptions in the method embodiment, with the same or corresponding technical effect achieved. To avoid repetition, details are not described herein again.

An embodiment of this application further provides a network-side device, including a processor and a communication interface. The communication interface is coupled to the processor. The processor is configured to run a program or instructions to implement the steps in the method embodiment shown in FIG. 10. The network-side device embodiment corresponds to the foregoing method embodiment on the network-side device, and each implementation process and implementation of the foregoing method embodiment can be applied to the network-side device embodiment, with the same technical effect achieved.

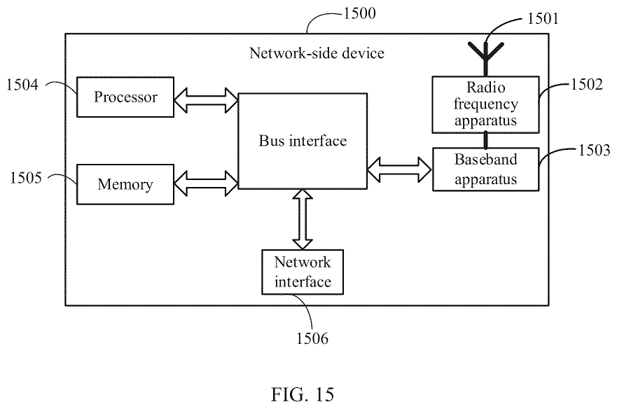

Specifically, as shown in FIG. 15, the network-side device 1500 includes an antenna 1501, a radio frequency apparatus 1502, and a baseband apparatus 1503. The antenna 1501 is connected to the radio frequency apparatus 1502. In an uplink direction, the radio frequency apparatus 1502 receives information by using the antenna 1501, and sends the received information to the baseband apparatus 1503 for processing. In a downlink direction, the baseband apparatus 1503 processes to-be-sent information, and sends the information to the radio frequency apparatus 1502; and the radio frequency apparatus 1502 processes the received information and then sends the information out by using the antenna 1501.

The radio frequency apparatus may be located in the baseband apparatus 1503. The method performed by the network-side device in the foregoing embodiment may be implemented in the baseband apparatus 1503, and the baseband apparatus 1503 includes a processor 1504 and a memory 1505.

The baseband apparatus 1503 may include, for example, at least one baseband unit, where a plurality of chips are disposed on the baseband unit. As shown in FIG. 15, one of the chips is, for example, the processor 1504, connected to the memory 1505, to invoke a program in the memory 1505 to perform the operation of the network-side device shown in the foregoing method embodiment.

The baseband apparatus 1503 may further include a network interface 1506, configured to exchange information with the radio frequency apparatus 1502, where the interface is, for example, a common public radio interface (common public radio interface, CPRI for short).

Specifically, the network-side device in this embodiment of the present invention further includes a program or instructions stored in the memory 1505 and capable of running on the processor 1504. When the processor 1504 invokes the program or instructions in the memory 1505, the method performed by each module shown in FIG. 12 is performed, with the same technical effect achieved. To avoid repetition, details are not described herein again.

An embodiment of this application further provides a system for a sidelink consistent listen-before-talk failure. The system includes a terminal and a network-side device. The terminal is configured to implement the steps of the method for processing a sidelink consistent listen-before-talk failure shown in FIG. 4. The network-side device is configured to implement the steps of the method for configuring a sidelink consistent listen-before-talk failure in FIG. 10.

An embodiment of this application further provides a readable storage medium. The readable storage medium stores a program or instructions. When the program or instructions are executed by a processor, each process of the foregoing embodiment of the method for processing a sidelink consistent listen-before-talk failure is implemented, or each process of the foregoing embodiment of the method for configuring a sidelink consistent listen-before-talk failure is implemented, with the same technical effect achieved. To avoid repetition, details are not described herein again.

The processor is a processor in the terminal in the foregoing embodiment. The readable storage medium includes a computer-readable storage medium, such as a computer read-only memory (ROM), a random access memory (RAM), a magnetic disk, or an optical disc. In some examples, the readable storage medium may be a non-transitory readable storage medium.

In addition, an embodiment of this application provides a chip. The chip includes a processor and a communication interface. The communication interface is coupled to the processor. The processor is configured to run a program or instructions to implement each process of the foregoing embodiment of the method for processing a sidelink consistent listen-before-talk failure is implemented, or each process of the foregoing embodiment of the method for configuring a sidelink consistent listen-before-talk failure is implemented, with the same technical effect achieved. To avoid repetition, details are not described herein again.

It should be understood that the chip provided in this embodiment of this application may also be referred to as a system-level chip, a system chip, a chip system, a system-on-chip, or the like.

In addition, an embodiment of this application provides a computer program or program product. The computer program or program product is stored in a storage medium. The computer program or program product is executed by at least one processor to implement each process of the foregoing embodiment of the method for processing a sidelink consistent listen-before-talk failure is implemented, or each process of the foregoing embodiment of the method for configuring a sidelink consistent listen-before-talk failure is implemented, with the same technical effect achieved. To avoid repetition, details are not described herein again.

It should be noted that in this specification, the term “comprise”, “include”, or any other variant thereof is intended to cover a non-exclusive inclusion, so that a process, a method, an article, or an apparatus that includes a list of elements not only includes those elements but also includes other elements that are not expressly listed, or further includes elements inherent to the process, method, article, or apparatus. In absence of more constraints, an element preceded by “includes a . . . ” does not preclude existence of other identical elements in the process, method, article, or apparatus that includes the element. In addition, it should be noted that the scope of the method and apparatus in the implementations of this application is not limited to performing the functions in an order shown or discussed, and may further include performing the functions in a substantially simultaneous manner or in a reverse order depending on the functions used. For example, the method described may be performed in an order different from that described, and various steps may be added, omitted, or combined. In addition, features described with reference to some examples may be combined in other examples.

Based on the foregoing descriptions of the implementations, a person skilled in the art may clearly understand that the foregoing embodiment methods can be implemented by using a computer software product in combination with a necessary general hardware platform, or by using hardware only. The computer software product is stored in a storage medium (such as a ROM, a RAM, a magnetic disk, or an optical disc), and includes several instructions for instructing a terminal or a network-side device to perform the methods described in the embodiments of this application.

The foregoing describes the embodiments of this application with reference to the accompanying drawings. However, this application is not limited to the foregoing specific embodiments. The foregoing specific embodiments are merely illustrative rather than restrictive. Inspired by this application, a person of ordinary skill in the art may develop many other manners of embodiments without departing from principles of this application and the protection scope of the claims, and all such manners of embodiments fall within the protection scope of this application.

What is claimed is:

1. A method for processing a sidelink consistent listen-before-talk failure, comprising:
determining, by a terminal, that a sidelink consistent listen-before-talk failure is triggered on a target resource; and
performing, by the terminal, a first operation, wherein
the first operation comprises at least one of the following:
clearing a first sidelink grant resource, wherein the first sidelink grant resource comprises the target resource on which the sidelink consistent listen-before-talk failure has been triggered;
performing resource selection or reselection for the first sidelink grant resource;
performing resource pool reselection; or
canceling the sidelink consistent listen-before-talk failure that has been triggered but has not been canceled on the target resource.

2. The method according to claim 1, wherein a resource granularity of the target resource comprises one of the following:
a resource block set;
a resource pool;
a bandwidth part;
a carrier; or
a carrier frequency.

3. The method according to claim 1, wherein the clearing, by the terminal, a first sidelink grant resource comprises:
clearing, by the terminal, the first sidelink grant resource comprising the target resource in a target time period, wherein the target time period is a continuous time period starting from a target time unit or target time, and the target time unit or target time is a time unit or time when it is determined that the sidelink consistent listen-before-talk failure is triggered on the target resource.

4. The method according to claim 3, wherein a duration of the continuous time period is determined based on at least one of the following:
a value M configured by a network side or specified by a protocol; or
a duration N of a target timer configured by the network side or specified by a protocol.

5. The method according to claim 4, wherein the target timer is one of the following:
a timer for the terminal to determine recovery of the target resource from the sidelink consistent listen-before-talk failure; or
a timer for the terminal to cancel the sidelink consistent listen-before-talk failure.

6. The method according to claim 1, wherein the performing, by the terminal, resource selection or reselection for the first sidelink grant resource comprises:
performing, by the terminal, resource selection or reselection for the first sidelink grant resource comprising the target resource in a target time period, wherein the target time period is a continuous time period starting from a target time unit or target time, and the target time unit or target time is a time unit or time when it is determined that the sidelink consistent listen-before-talk failure is triggered on the target resource.

7. The method according to claim 1, wherein the method further comprises:
continuously performing, by the terminal, a sending resource selection or reselection check until the terminal triggers resource pool reselection.

8. The method according to claim 1, wherein the performing, by the terminal, resource pool reselection comprises:
in a case that it is determined that the sidelink consistent listen-before-talk failure is triggered on the target resource, or resource pool reselection is triggered, or clearing, or resource selection or reselection is performed for the first sidelink grant resource, performing, by the terminal, corresponding resource pool reselection based on a type of a target logical channel associated with a target object, wherein the target object comprises one of the following associated with the first sidelink grant resource: a sidelink process, a transport block (TB), or a media access control (MAC) protocol data unit (PDU).

9. The method according to claim 8, wherein the performing, by the terminal, corresponding resource pool reselection based on a type of a target logical channel associated with a target object comprises:
in a case that the target logical channel is a logical channel for transmitting a sidelink discovery signal, performing, by the terminal, at least one of the following:
performing, by the terminal, resource pool reselection to a first resource pool, wherein the first resource pool is a discovery resource pool comprising a resource block set on which no sidelink consistent listen-before-talk failure has been triggered;
in a case that there is no discovery resource pool comprising a resource block set on which no sidelink consistent listen-before-talk failure has been triggered, terminating, by the terminal, resource pool reselection;
in a case that there is no discovery resource pool comprising a resource block set on which no sidelink consistent listen-before-talk failure has been triggered, performing, by the terminal, resource pool reselection to a second resource pool, wherein the second resource pool is a resource pool other than a discovery resource pool, and the second resource pool comprises a resource block set on which no sidelink consistent listen-before-talk failure has been triggered;
in a case that there is no resource pool comprising a resource block set on which no sidelink consistent listen-before-talk failure has been triggered, terminating, by the terminal, resource pool reselection; or
in a case that there is no resource pool comprising a resource block set on which no sidelink consistent listen-before-talk failure has been triggered, performing, by the terminal, resource pool reselection to an exceptional resource pool.

10. The method according to claim 9, wherein the discovery resource pool is at least one discovery resource pool indicated by a sidelink discovery signal transmission resource pool selection parameter configured in a sidelink bandwidth part discovery resource pool configuration.

11. The method according to claim 8, wherein the performing, by the terminal, corresponding resource pool reselection based on a type of a target logical channel associated with a target object comprises:
in a case that sidelink feedback of the target logical channel is enabled, performing, by the terminal, at least one of the following:
performing, by the terminal, resource pool reselection to a third resource pool configured with a physical sidelink feedback channel PSFCH resource, wherein the third resource pool comprises a resource block set on which no sidelink consistent listen-before-talk failure has been triggered;
in a case that there is no resource pool configured with a PSFCH resource and comprising a resource block set on which no sidelink consistent listen-before-talk failure has been triggered, terminating, by the terminal, resource pool reselection; or
in a case that there is no resource pool configured with a PSFCH resource and comprising a resource block set on which no sidelink consistent listen-before-talk failure has been triggered, performing, by the terminal, resource pool reselection to an exceptional resource pool.

12. The method according to claim 8, wherein the performing, by the terminal, corresponding resource pool reselection based on a type of a target logical channel associated with a target object comprises:
in a case that sidelink feedback of the target logical channel is not enabled or that the target logical channel is not a logical channel for transmitting a sidelink discovery signal, performing, by the terminal, at least one of the following:
performing, by the terminal, resource pool reselection to any fourth resource pool comprising a resource block set on which no sidelink consistent listen-before-talk failure has been triggered; or
in a case that there is no resource pool comprising a resource block set on which no sidelink consistent listen-before-talk failure has been triggered, terminating, by the terminal, resource pool reselection.

13. The method according to claim 12, wherein the fourth resource pool comprises a normal resource pool or an exceptional resource pool.

14. The method according to claim 12, wherein the performing, by the terminal, resource pool reselection to the fourth resource pool comprises:
preferentially reselecting, by the terminal, the fourth resource pool configured with a PSFCH resource.

15. The method according to claim 1, wherein the canceling, by the terminal, the sidelink consistent listen-before-talk failure that has been triggered but has not been canceled on the target resource comprises:
in a case that at least one of the following is met, canceling, by the terminal, the sidelink consistent listen-before-talk failure that has been triggered but has not been canceled on the target resource:
a resource pool comprising the target resource is released;
the terminal enters a radio resource control (RRC) idle mode or an RRC inactive mode from an RRC connected mode; or
the terminal enters the RRC connected mode from the RRC idle mode or the RRC inactive mode.

16. A method for configuring a sidelink consistent listen-before-talk failure, comprising:
sending, by a network-side device, configuration information to a terminal, wherein the configuration information is used to indicate a target time period, and after a sidelink consistent listen-before-talk failure is triggered on a target resource, the target time period is used for the terminal to determine to clear a first sidelink grant resource comprising the target resource in the target time period, or determine to perform resource selection or reselection for a first sidelink grant resource comprising the target resource in the target time period.

17. The method according to claim 16, wherein the configuration information comprises one of the following:
first indication information, used to indicate a value M; or
second indication information, used to indicate a duration N of a target timer.

18. The method according to claim 17, wherein the target timer comprises one of the following:
a timer for the terminal to determine recovery of the target resource from the sidelink consistent listen-before-talk failure; or
a timer for the terminal to cancel the sidelink consistent listen-before-talk failure.

19. A network-side device, comprising a processor and a memory, wherein the memory stores a program or instructions capable of running on the processor, and when the program or instructions are executed by the processor, the steps of the method for configuring a sidelink consistent listen-before-talk failure according to claim 16 are implemented.

20. A terminal, comprising a processor and a memory, wherein the memory stores a program or instructions capable of running on the processor, and when the program or instructions are executed by the processor, the processor is configured to:
determine, by a terminal, that a sidelink consistent listen-before-talk failure is triggered on a target resource; and
perform a first operation, wherein
the first operation comprises at least one of the following:
clearing a first sidelink grant resource, wherein the first sidelink grant resource comprises the target resource on which the sidelink consistent listen-before-talk failure has been triggered;
performing resource selection or reselection for the first sidelink grant resource;
performing resource pool reselection; or
canceling the sidelink consistent listen-before-talk failure that has been triggered but has not been canceled on the target resource.
